(19) United States
(12) Patent Application Publication
(10) Pub. No.: US 2006/0055944 A1
(43) Pub. Date: Mar. 16, 2006

(54) Image processing apparatus, image processing method and program

(75) Inventors: Jun Minakuti, Sakai-shi (JP); Atsushi Ueda, Ritto-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA PHOTO IMAGING, INC.

(21) Appl. No.: 11/096,987

(22) Filed: Apr. 1, 2005

(30) Foreign Application Priority Data
Sep. 14, 2004 (JP) JP2004-266965

(51) Int. Cl. G06K 15/02

(52) U.S. Cl. 358/1.2

(57) ABSTRACT

An image processing apparatus for collectively performing image processes on at least one image with respect to a plurality of processing items. The image processing apparatus includes a specifying part for specifying several pieces of setting data for use in deciding image processing details related to at least one image, the several pieces of setting data each defining processing details with respect to at least one of the plurality of processing items, and a deciding part for deciding the image processing details with respect to each one of the plurality of processing items based on the several pieces of setting data and order of priority between the several pieces of setting data.

This application is based on application No. 2004-266965 filed in Japan, the contents of which are hereby incorporated by reference.

### BACKGROUND OF THE INVENTION

1. Field of the Invention

The present invention relates to an image processing technique and more particularly, to a technique for collectively performing various types of image processes.

2. Description of the Background Art

Images captured for example by a digital camera have been subjected to an image processing technique for performing image processing with respect to a variety of items including color balance correction, brightness correction and the like. As an example, these image processes are performed by executing a certain program for image processing on a personal computer. Such an processing technique provides an improved image quality.

Software programs responsible for these image processes include one that has a batch processing function for collectively performing image processes with respect to a plurality of items on one or more objective images. According to this batch processing function, a file (also called as a “batch file”) defining batch processing in which processing details with respect to a plurality of items are to be collectively executed is used to set image processing details related to an objective image.

Such a batch processing function is effectively usable especially in the case where a plurality of images are all subjected to the same processing, in which case enhanced efficiency of processing can be provided.

However, the foregoing batch processing function is applicable only to the case where a plurality of images are all subjected to the same processing, and is not applicable to the case where even part of the processing differs between the images. That is, the foregoing batch processing function is inapplicable to all the images when processing with respect to only a few of a plurality of items in image processing differs between the images.

Further, when a single image is subjected to processing in which processing details to be executed differ from settings defined by a certain batch file with respect to a few of a plurality of processing items, this batch file cannot be used for setting operations.

As discussed, when image processing details to be executed differ from settings defined by a batch file with respect to only one of a plurality of items, the foregoing batch processing function is not applicable.

### SUMMARY OF THE INVENTION

When image processes with respect to a plurality of processing items are to be collectively performed, it is an object of the present invention to provide a technique realizing a high degree of efficiency in setting image processing details.

According to one aspect of the present invention, an image processing apparatus comprises: a specifying part for specifying several pieces of setting data for use in deciding image processing details related to at least one image, the several pieces of setting data each defining processing details with respect to at least one of the plurality of processing items; and a deciding part for deciding the image processing details with respect to each one of the plurality of processing items based on the several pieces of setting data and order of priority between the several pieces of setting data.

The present invention is also directed to an image processing method and a program product.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows the configuration of an image processing apparatus;

FIG. 2 is a functional block diagram of the image processing apparatus;

FIG. 3 is a flow chart explaining processing in the image processing apparatus;

FIG. 4 shows an operation screen during execution of a program;

FIG. 5 shows an operation screen for individually setting image processing details;

FIG. 6 shows a plurality of items displayed in an item display region R5;

FIG. 7 is a setting dialog with respect to brightness correction;

FIG. 8 shows an operation screen for making common settings;

FIG. 9 schematically shows settings of each image;

FIG. 10 shows settings defined by each setting data;

FIGS. 11 and 12 each explain how image processing details are decided based on order of priority;

FIG. 13 schematically shows settings according to modifications; and

FIG. 14 shows respective settings with respect to processing items according to the modifications.

### DESCRIPTION OF THE PREFERRED EMBODIMENTS

A preferred embodiment of the present invention will be discussed below with reference to drawings.

<Configuration>

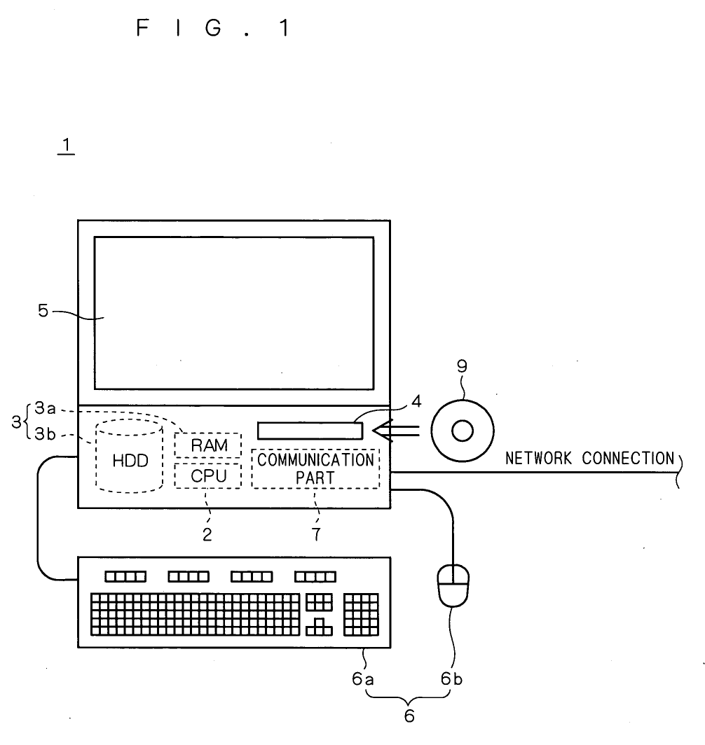

FIG. 1 is a schematic view of an image processing apparatus according to a preferred embodiment of the present invention. As seen from FIG. 1, the image processing apparatus 1 is configured as a computer system (hereinafter also simply referred to as a “computer”). More specifically, this computer (image processing apparatus) comprises a CPU 2, a storage part 3, a media drive 4, a display part 5 which may be a liquid crystal display, an input part 6 including for example a keyboard 6a and a mouse 6b, and a communication part 7 which may be a network card. The storage part 3 has a main storage 3a including a semiconductor memory such as a RAM, and an auxiliary storage 3b which may be a hard disk drive (HDD). The media drive 4 is capable of reading information stored in a portable recording medium 9 which may be a CD-ROM, DVD (digital versatile disk), flexible disk, memory card or the like.

The image processing apparatus 1 reads a software program PG (hereinafter also simply referred to as a “program”) stored in the recording medium 9 and causes for example the CPU 2 to execute the program PG, thereby becoming operative to perform various functions discussed later. The program realizing each function is not necessarily supplied from the recording medium 9. This program may alternatively be supplied to the computer through a network such as a LAN or the Internet.

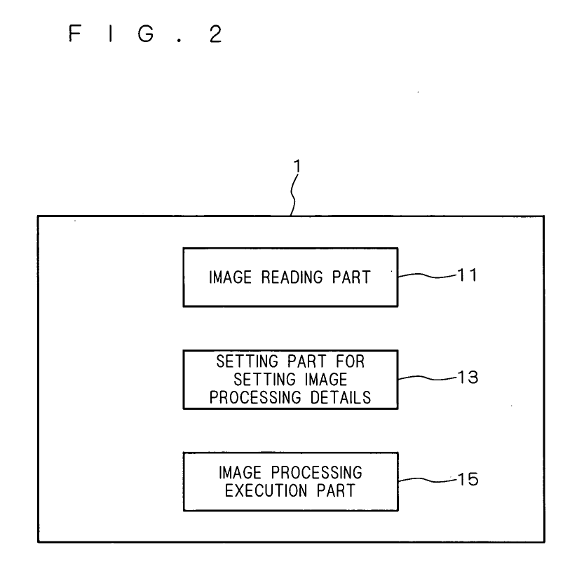

FIG. 2 is a functional block diagram of the image processing apparatus 1. With reference to FIG. 2, the image processing apparatus 1 comprises an image recording part 11, a setting part 13 for setting image processing details, and an image processing execution part 15.

The image recording part 11 serves to read data of an image to be processed in a manner capable of being handled in the program PG. The setting part 13 serves to set image processing details with respect to a plurality of items (to be discussed later). Image processing details on each image with respect to a plurality of items are stored in a storage area under management of the program PG. The image processing execution part 15 serves to actually perform image processing with respect to each item based on the image processing details set by the setting part 13.

When several pieces of setting data are specified for use in setting image processing details related to a certain image, the setting part 13 makes reference to these several pieces of setting data and order of priority therebetween to decide image processing details with respect to each item.

Next, the foregoing processing will be discussed in more detail.

<Operations>

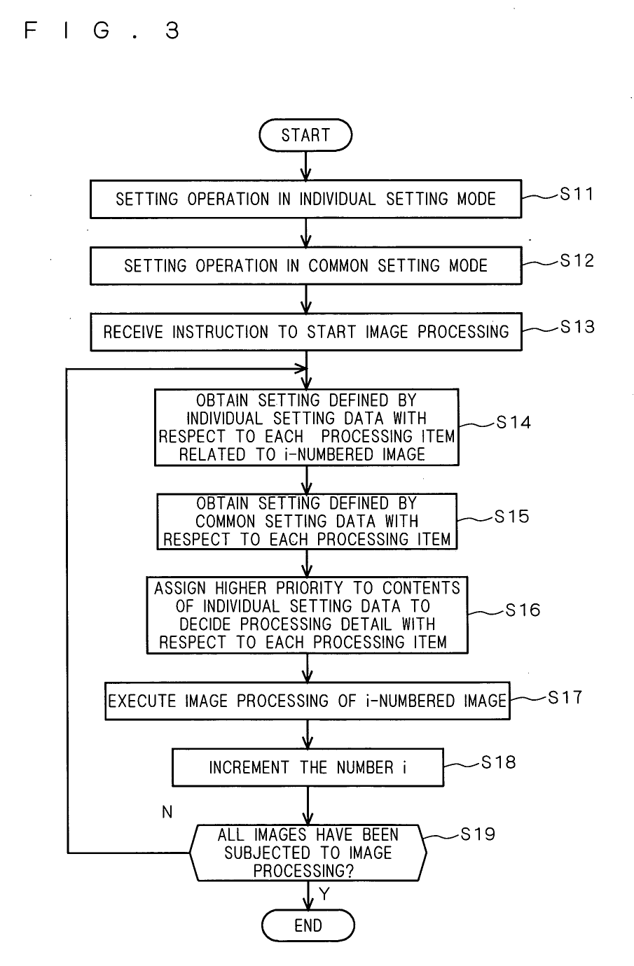

FIG. 3 is a flow chart explaining processing in the image processing apparatus 1.

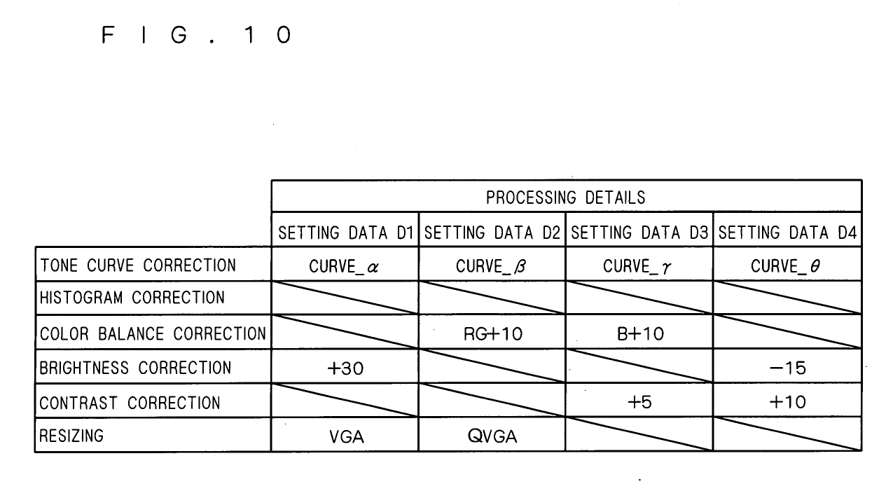

In the following, making reference for example to FIG. 3, it will be discussed how image processing details related to a plurality of (here, four) images PA, PB, PC and PD are decided in two setting modes including a common setting mode and an individual setting mode. Based on the processing details thus decided, the images PA through PD are collectively subjected to image processing (see also FIG. 9). Image processing details to be shared between a plurality of images are set in the common setting mode. In the individual setting mode, image processing details are (individually) set for each image.

More particularly, in the example discussed below, image processing details to be shared between all of the images PA through PD are set in the common setting mode, and image processing details related to the two image PB and PD are individually set in the individual setting mode. It is assumed in this preferred embodiment that the processing details set in the individual setting mode are assigned higher priority than the processing details set in the common setting mode. That is, of processing details defined both in the common and individual setting modes with respect to the same item, the processing details defined in the individual setting mode are assigned higher priority. Thus, setting in the individual setting mode is applied as the processing details with respect to this same item.

For the convenience of description, the process flow in the following includes (1) setting operations in the individual setting mode and thereafter, (2) setting operations in the common setting mode. Alternatively, the process flow may proceed in reverse order. Namely, (1) setting operations in the individual setting mode may follow (2) setting operations in the common setting mode.

First, (1) setting operations in the individual setting mode (step S11) will be discussed.

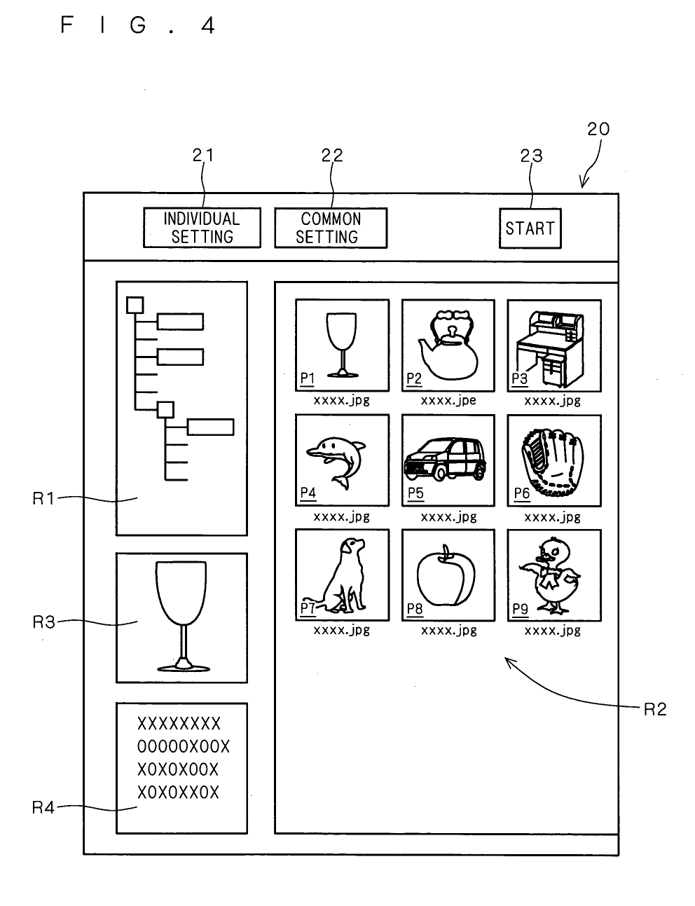

FIG. 4 shows an operation screen 20 during execution of the program PG.

The operation screen 20 is divided into a plurality of regions including R1, R2, R3 and R4. The region R1 is allocated for display of a folder tree, the region R2 is for display in list form, the region R3 is for preview display, and the region R4 is for information display.

When an operator specifies a certain folder by a mouse operation or the like, each image in the specified folder is displayed as a thumbnail image in the region R2 while being identified by its file name. Alternatively, only file names of images may be listed.

When a desired image is selected from a plurality of images displayed in the region R2 (including images P1 through P9) by a mouse operation (which is more particularly a single-click), a preview screen of the selected image is displayed in the region R3 and various types of information such as tag information of the selected image is displayed in the region R4.

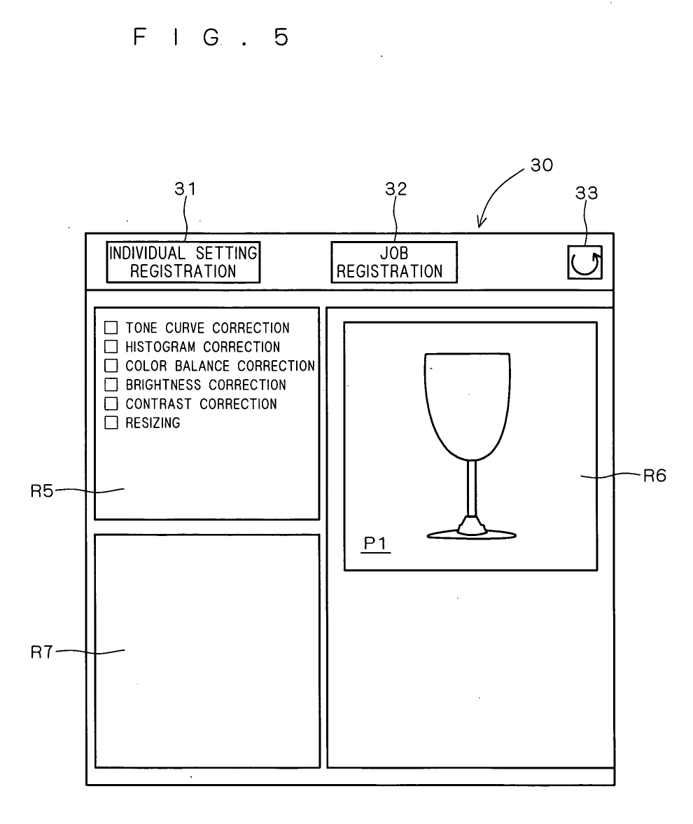

Making reference to the respective display contents in the regions R1 through R4, the operator selects the image PB (which may for example be the image P1) as a desirable objective image of processing. More specifically, the operator selects the desired image PB from the images displayed in the region R2 by a single-click, and presses an individual setting button 21 in the upper portion of the operation screen 20. In response to this selection, the image processing apparatus 1 recognizes the image PB (the image P1, for example) has been selected as an objective image of individual setting of image processing, creates a new window, and displays an operation screen 30 (see FIG. 5) on the display part 5.

FIG. 5 shows the operation screen 30 for designating and implementing image processing details. With reference to FIG. 5, the operation screen 30 is divided into an item display region R5 in which a plurality of items in image processing are listed, an image display region R6 for displaying an objective image, and an information display region R7 for displaying detailed information of the objective image.

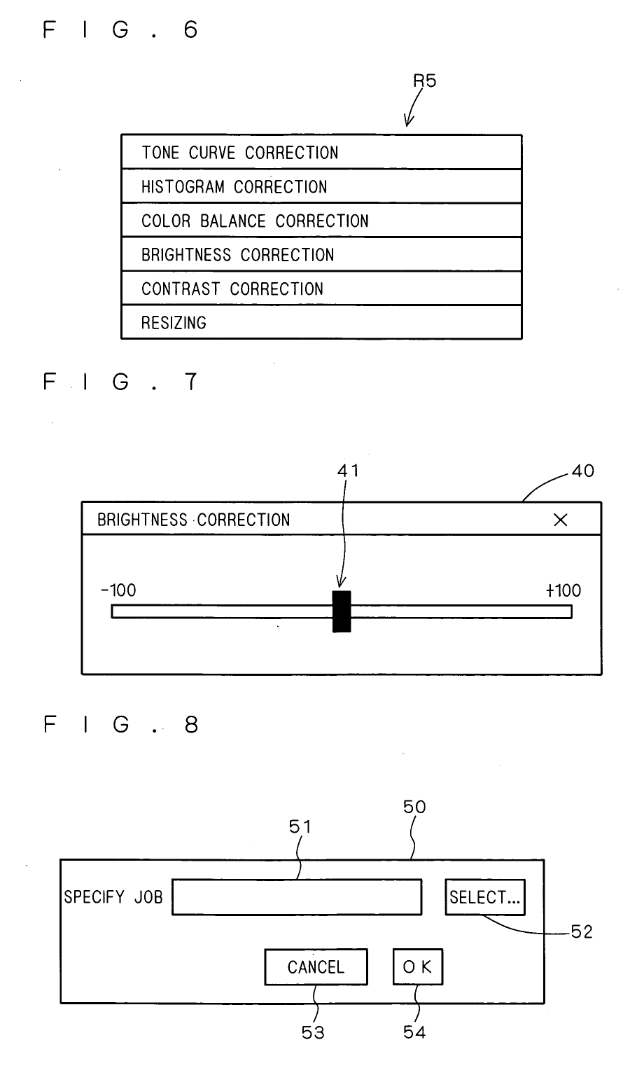

FIG. 6 shows a plurality of items displayed in the item display region R5. With reference to FIG. 6, as items in image processing, tone curve correction, histogram correction, color balance correction, brightness correction, contrast correction and resizing are listed.

When a certain item in the region R5 is specified by a mouse operation (which is more particularly a double-click) on the operation screen 30 of FIG. 5, a setting dialog appears which sets the selected item in detail. As an example, when “brightness correction” is selected, a setting dialog 40 appears as shown in FIG. 7. The operator moves a slider 41 in the setting dialog 40 to the left and right by a mouse operation, whereby a parameter for brightness correction is allowed to have an arbitrary value ranging between −100 and +100.

The other items are subjected to the same setting, thereby suitably setting respective correction parameters of the items. The operator performs the same setting with respect to each one of a plurality of items to set respective image processing details of the plurality of items. Thereafter the operator presses an individual setting registration button 31 to store the image processing details thereby decided. When setting operations of image processing details with respect to desired items are completed, the operator presses a close button 33 to close the operation screen 30. By the time the program PG ends, the image processing details of the image PB are stored in the storage part 3 under management of the program PG.

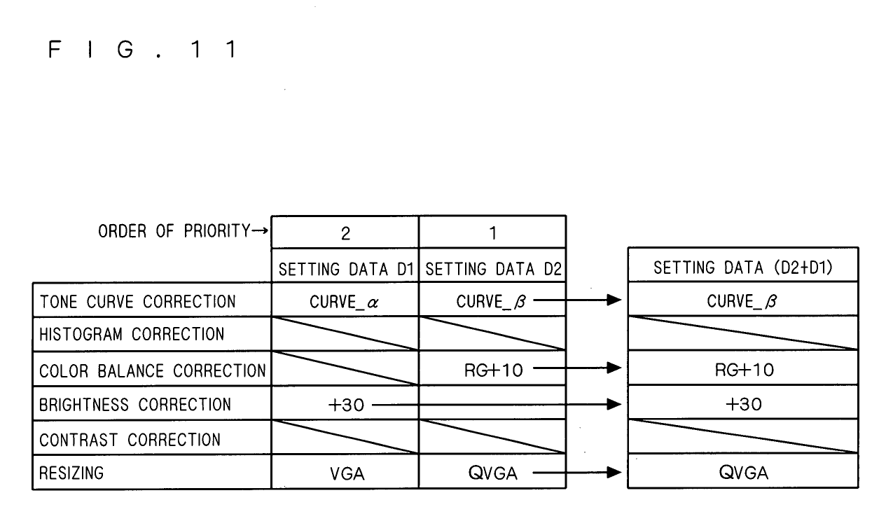

The setting operations related to the image PB in the individual setting mode are thus finished, in response to which setting data related to the image PB (which may for example be setting data D2 indicated in FIG. 10) is created which defines individual settings of the image PB. The setting data D2 defines a parameter “CURVE_β” for tone curve correction, a parameter corresponding to “RG+10” for color balance correction, and a parameter corresponding to “QVGA” for resizing. Here, “RG+10” means correction to increase respective values of the R (red) and G (green) components by “10” stages (for example, 10%), and “QVGA” means correction to change an image size to QVGA size (320×240 pixels). The setting data D2 does not define settings for histogram correction, brightness correction and contract correction.

The image PD is subjected to setting operations in the individual setting mode in a similar manner, in response to which setting data related to the image PD (which may for example be setting data D4 indicated in FIG. 10) is created which defines individual settings of the image PD. The setting data D4 defines a parameter “CURVE_θ” for tone curve correction, a parameter corresponding to “−15” for brightness correction, and a parameter corresponding to “+10” for contrast correction. The setting data D4 does not define parameters for histogram correction, color balance correction and resizing.

Following the flow discussed above, setting operations in the individual setting mode are completed.

In the image processing apparatus 1, setting data defining the results of setting (settings) obtained in the foregoing individual setting mode is stored as a job file. More specifically, a certain image PZ is subjected to the same setting operations as those discussed above to define the image processing details related to the image PZ. Thereafter a job registration button 32 is pressed to display a dialog not shown for file save on the display part 5. Using this dialog, the operator gives an instruction to save the results of setting of the image processing details related to the image PZ as a job file identified by a desirable file name. The image processing apparatus 1 creates a job file identified by the file name specified by the operator, and saves the setting data defining the image processing details related to the image PZ as this job file. As discussed later, the job file thereby saved is used in setting operations of image processing details in the common setting mode.

Next, (2) setting operations in the common setting mode (step S12 in FIG. 3) will be discussed.

The operator selects four thumbnail images PA through PD to be processed by a mouse operation or the like on the operation screen 20 of FIG. 4, and presses a common setting button 22 in the upper portion of the operation screen 20.

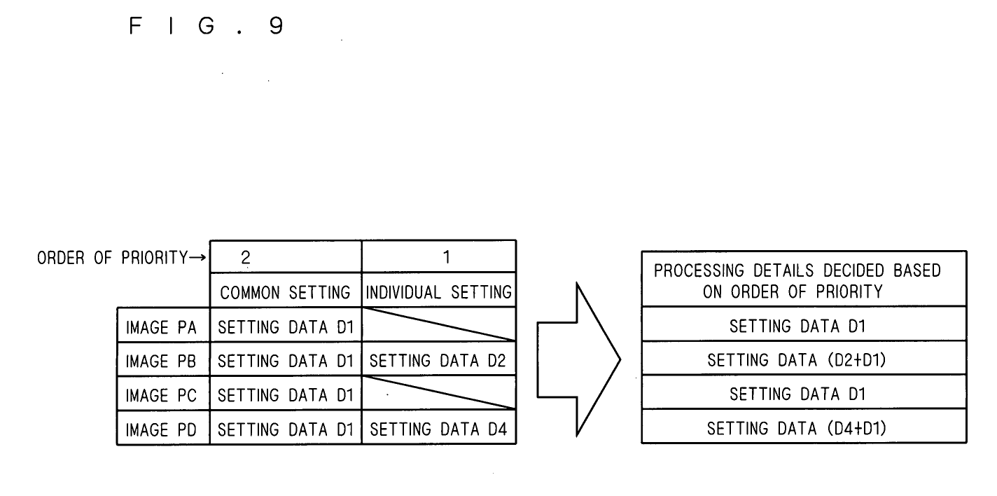

In response to this selection, the image processing apparatus 1 creates a new dialog for common setting related to image processing, and displays an operation screen 50 (see FIG. 8) on the display part 5.

FIG. 8 shows the operation screen 50 for specifying setting data for use in common setting data. With reference to FIG. 8, the operation screen 50 has a file name input region 51 for specifying setting data, a selection button 52 for selecting this setting data from a data file previously stored, a cancel button 53, and an OK button 54.

More specifically, the operator presses the selection button 52 to cause the image processing apparatus 1 to display a dialog (not shown) for opening a file on the display part 5. Using this dialog, the operator selects by a mouse operation a job file to be used in common setting. It is assumed a job file specifying setting data D1 is selected from a plurality of job files previously stored related to a plurality of images.

In response to this selection, the image processing apparatus 1 closes this dialog, reads the job file selected by the operator, and displays its file name on the file name input region 51 in the operation screen 50. When the operator presses the OK button 54, the image processing apparatus 1 closes the operation screen 50.

Following the flow discussed above, setting operations in the common setting mode are completed.

Next, the operator presses a start button 23 (FIG. 4) to start image processing.

When the image processing apparatus 1 receives the instruction to start image processing triggered by the press of the start button 23 (step S13 in FIG. 3), subsequent steps S14 through S19 are repeated on the four images PA through PD. Then the image processing details related to each one of the images PA through. PD are decided to execute image processing details thereby decided.

More specifically, the setting with respect to each processing item defined by the individual setting data is obtained related to an i-numbered image (first image PA) (step S14). Thereafter in step S15, the setting with respect to each processing item defined by the common setting data is obtained related to the i-numbered image (step S15). The settings in the individual setting data are assigned higher priority to decide the setting of the i-numbered image with respect to each processing item (step S116).

According to the settings decided in step S16, the i-numbered image is then subjected to image processing (step S17). Thereafter the number i is incremented (step S18). Then it is determined whether all the images are subjected to image processing (step S19). These operations (steps S14 through S19) are repeated a plurality of times (here, four times), whereby image processing of all the objective images is completed.

FIGS. 9 through 12 explain how image processing details are decided. With reference to FIGS. 9 through 12, it will be discussed in more detail how image processing details are decided (step S16).

FIG. 9 schematically shows the respective settings related to the images PA through PD. In the example of FIG. 9, the setting data D1 is specified for use in the common setting mode to set the image processing details to be shared between all of the images PA through PD. The setting data D2 and D4 are specified for use in the individual setting mode to set the image processing details related to some images including PB and PD of the plurality of images PA through PD.

Based on order of priority between several pieces of setting data D1, D2 and D4, the image processing apparatus 1 decides image processing details with respect to a plurality of items to be executed on each one of the images PA through PD.

Only the common setting data D1 is applied to decide the image processing details related to the images PA and PC. It is thus decided the images PA and PC are to be subjected to image processing with the same processing details. The setting data D1 defines a parameter “CURVE_α” for tone curve correction, a parameter corresponding to “+30” for brightness correction, and a parameter corresponding to “VGA” for resizing (see FIG. 10). These settings using the setting data D1 are thus directly applied as the image processing details related both to the images PA and PC.

The image PB is subjected to setting operations using not only the common setting data D1 but also the individual setting data D2 (see FIG. 9). Assigning the higher priority to the contents of the setting data D2, the image processing apparatus 1 merges the setting data D1 and D2 to decide processing details with respect to each item.

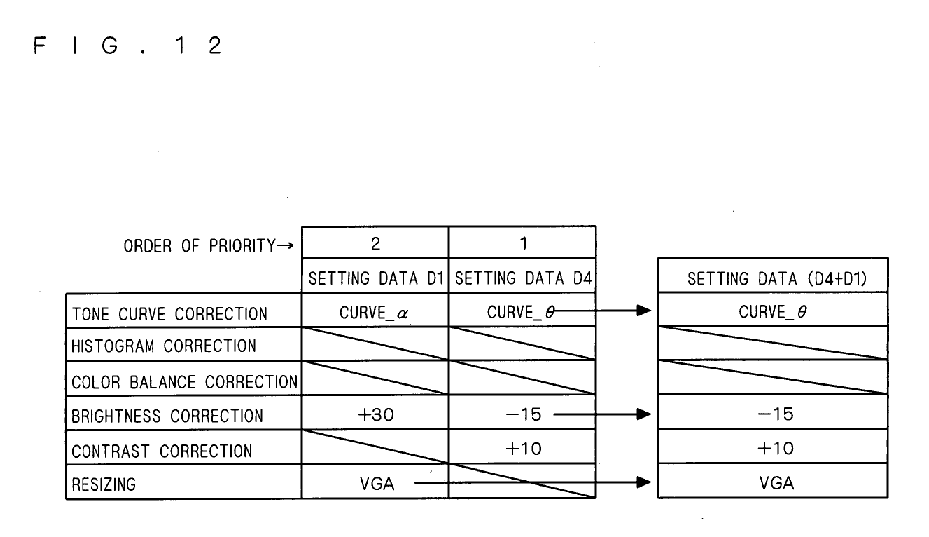

FIG. 11 explains how image processing details related to the image PB are decided based on such order of priority. In the image processing apparatus 1, it is assumed the individual setting data D2 is assigned the relatively higher priority than the common setting data D1.

Of contents of several pieces of setting data D1 and D2, the contents each defining processing details with respect to the same item (more particularly, tone curve correction and resizing), content of the setting data D2 assigned the higher priority than the setting data D1 is applied as the image processing details with respect to this same item. That is, the contents of the setting data D1 are disregarded. More specifically, with respect to tone curve correction, “CURVE_β” as one of the contents of the setting data D2 is applied. “QVGA” as one of the contents of the setting data D2 is applied with respect to resizing.

Of a plurality of processing items, with respect to such an item for which only the setting data D1 defines details whereas the setting data D2 does not include the setting with respect thereto, the setting defined by the setting data D1 is applied as image processing details. More specifically, with respect to brightness correction, “+30” as one of the contents of the setting data D1 is applied.

Of a plurality of processing items, with respect to such an item for which only the setting data D2 defines details whereas the setting data D1 does not include the setting with respect thereto, the setting defined by the setting data D2 is applied as image processing details. More specifically, with respect to color balance correction, “RG+10” as one of the contents of the setting data D2 is applied.

Of a plurality of processing items, with respect to such an item for which neither the setting data D1 nor D2 includes setting thereof, no image processing is performed. More specifically, no image processing is performed with respect to histogram correction and contrast correction.

The image processing details related to the image PB are thus decided.

The image PD is subjected to setting operations using not only the common setting data D1 but also the individual setting data D4 (see FIG. 9). Assigning the higher priority to the contents of the setting data D4, the image processing apparatus 1 merges the setting data D1 and D4 to decide processing details with respect to each item.

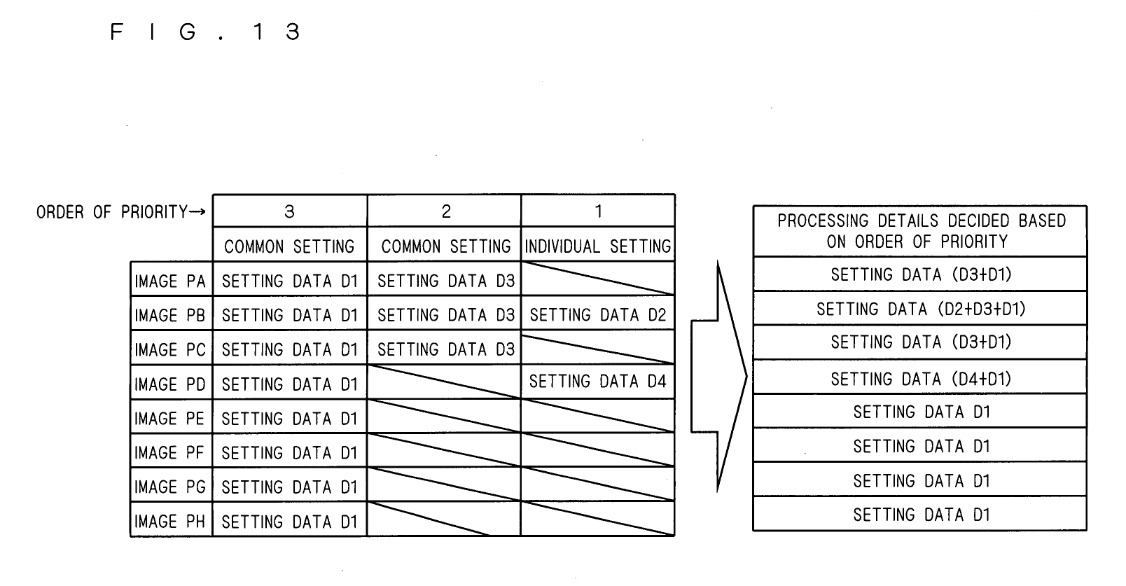

FIG. 12 explains how image processing details related to the image PD are decided based on such order of priority. In the image processing apparatus 1, it is assumed the individual setting data D4 is assigned the relatively higher priority than the common setting data D1.

Of contents of several pieces of setting data D1 and D4, the contents each defining processing details with respect to the same item, content of the setting data D4 assigned the higher priority than the setting data D2 is applied as the image processing details with respect to this same item. More particularly, with respect to tone curve correction, “CURVE_θ” as one of the contents of the setting data D4 is applied. With respect to brightness correction, “−15” as one of the contents of the setting data D4 is applied.

With respect to such a processing item for which only the setting data D1 defines details whereas the setting data D4 does not include the setting with respect thereto, the setting defined by the setting data D1 is applied as image processing details. More specifically, with respect to resizing, “VGA” as one of the contents of the setting data D1 is applied.

With respect to such an item for which only the setting data D4 defines details whereas the setting data D1 does not include the setting with respect thereto, the setting defined by the setting data D4 is applied as image processing details. More specifically, with respect to contrast correction, “+10” as one of the contents of the setting data D4 is applied.

With respect to such an item for which neither the setting data D1 nor D4 includes setting thereof, no image processing is performed. More specifically, no image processing is performed with respect to histogram correction and color balance correction.

Based on order of priority between several pieces of setting data D1, D2 and D4, the image processing apparatus 1 thus decides image processing details with respect to a plurality of items to be executed on each one of the images PA through PD.

As discussed, when image processing details with respect to a plurality of items are to be collectively performed in the image processing apparatus 1, merger of the common setting data D1 and individual setting data D2, and merger of the common setting data D1 and individual setting data D4 are performed based on order of priority between the common setting data D1 and the individual setting data D2 and D4. Then image processing details are decided with respect to a plurality of items. By defining fundamental image processing details as common setting data and defining additional (exceptional) image processing details as individual setting data, image processing details can be set with a high degree of efficiency.

In the process flow discussed above, the common setting data D1 is specified for use in deciding image processing details to be shared between all of the four images PA through PD, whereas for deciding image processing details related to some image PB (, PD) selected from the four images PA through PD, the individual setting data D2 (, D4) is specified. Thus additional processing details for each image can be defined using the individual setting data D2 (, D4) while defining fundamental processing details related to a plurality of images using the common setting data D1. As a result, a considerably high degree of efficiency can be provided in setting operation.

<Modifications>

In the preferred embodiment described above, the common setting data D1 is applied to decide processing details related to all of a plurality of images, whereas the setting data D2 and D4 are applied to decide image processing details related to some of a plurality of images. Based on a combination of the common setting and individual setting data, each image is subjected to setting operation of image processing details with respect to each item. Alternatively, image processing details may be decided based on a combination of certain common setting data (first common setting data) and other common setting data (second common setting data). More specifically, the second common setting data is applied in place of the foregoing individual setting data to set image processing details related to some of a plurality of images. Order of priority is determined between the first and second common setting data and the setting data assigned the higher priority takes precedence over the other setting data, to decide image processing details with respect to each item.

In the preferred embodiment described above, image processing details with respect to each item is decided based on a combination of two setting data. Alternatively, a combination of three or more setting data may be used to set image processing details with respect to each item. By way of example, order of priority may be determined between three setting data. Making reference to this order of priority, these three setting data are applied to set image processing details with respect to each item.

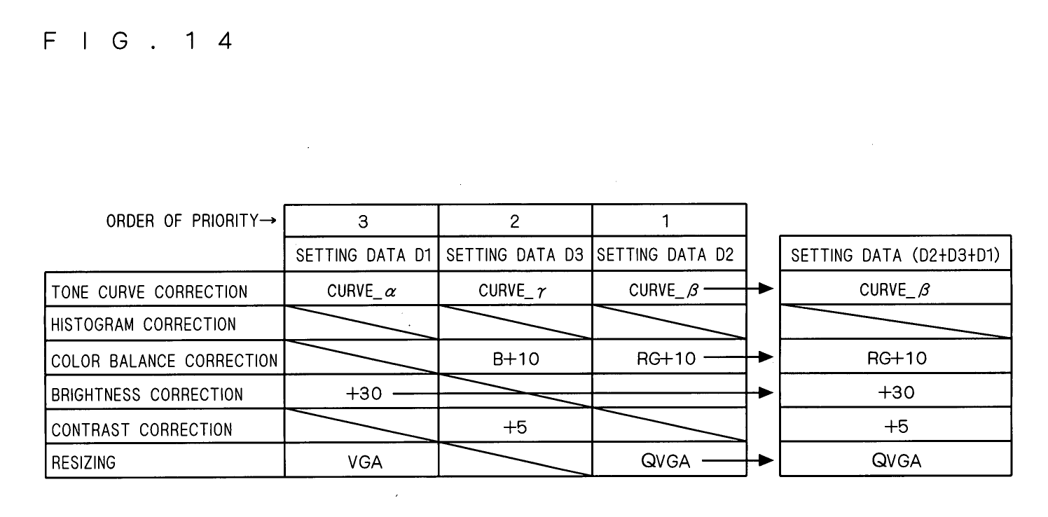

FIG. 13 explains these modifications. In the example of FIG. 13, common setting data D1, D3 and individual setting data D2, D4 are used to set respective image processing details related to eight images PA through PH.

In the example of FIG. 13, the common setting data D1 is applied to set the image setting details of the eight images PA through PH, the common setting data D3 is applied to set the image setting details of the three images PA, PB and PC, the individual setting data D2 is applied to set the image processing details of the image PB, and the individual setting data D4 is applied to set the image processing details of the image PD.

In this case, image processing details may be decided based on order or priority between several pieces of setting data. Here, “order of priority” can be shared between images and between processing items.

More specifically, assigning the relatively higher priority to the contents of the setting data D3, the setting data D1 and D3 are merged to decide the respective image processing details of the images PA and PC with respect to each item.

Assigning the highest priority to the contents of the setting data D2, and giving second and third priorities to the setting data D3 and D1, respectively, the three setting data D2, D3 and D1 are merged to decide image processing details of the image PB with respect to each item.

FIG. 14 shows how processing details with respect to each item is decided based on the three setting data D2, D3 and D1 and order of priority therebetween. In the image processing apparatus 1, of several pieces of setting data defining processing details with respect to each item, the contents of the setting data assigned the highest priority are applied as image processing details related to each image. As an example, with respect to “resizing” related to the image PB, of the setting data D1 and D2 each defining the processing details with respect to “resizing”, the content of the setting data D2 assigned the higher priority is applied as the image processing details related to the image PB.

Assigning the higher priority to the contents of the setting data D4, the setting data D4 and D1 are merged to decide the image processing details related to the image PD (see FIG. 13). Regarding the images PE, PF, PG and PH, the setting data D1 is used to decide processing details with respect to each item.

According to these exemplary settings, the common setting data D1 to be shared between a relatively large number of images, the common setting data D3 to be shared between a relatively small number of images, and the individual setting data D2 and D4 intended for individual settings are suitably applied to efficiently set image processing details of each image covering a plurality of items. As a specific example, with reference to FIG. 14, the content of the setting data D3 is applied with respect to “contrast correction” of the image PB. As seen from the comparison with FIG. 11, on the basis of the setting data D1 and D2, the settings reltaed to the image PB also reflect the contents defined by the setting data D3.

In the preferred embodiment described above, a plurality of images are subjected to setting operations of image processing details. However, the foregoing conception may alternatively be applied to setting operations of image processing details related for example to a single image. More particularly, for setting the image processing details of the single image PA, two setting data D1 and D2 may both be applied. Based on order of priority between these two setting data D1 and D2, the processing details with respect to each item may be decided in the same way as discussed above. Accordingly, image processing details with respect to each item is decided on the basis of certain setting data (which may for example be the setting data D1) while using other setting data (which may for example be the setting data D2), whereby image processing details can be modified or added with respect to some of the items.

While the invention has been shown and described in detail, the foregoing description is in all aspects illustrative and not restrictive. It is therefore understood that numerous modifications and variations can be devised without departing from the scope of the invention.

What is claimed is:

1. An image processing apparatus for collectively performing image processes on at least one image with respect to a plurality of processing items, said image processing apparatus comprising:
a specifying part for specifying several pieces of setting data for use in deciding image processing details related to at least one image, said several pieces of setting data each defining processing details with respect to at least one of said plurality of processing items; and
a deciding part for deciding said image processing details with respect to each one of said plurality of processing items based on said several pieces of setting data and order of priority between said several pieces of setting data.

2. The image processing apparatus according to claim 1,
wherein, of contents of some of said several pieces of setting data, said contents each defining processing details with respect to an item of said plurality of items, said deciding part applies content of setting data assigned the highest priority of some of several pieces of setting data as said image processing details.

3. The image processing apparatus according to claim 1,
wherein said several pieces of setting data include first setting data and second setting data,
wherein said first setting data is specified for use in deciding image processing details to be shared among all of a plurality of images, and
wherein said second setting data is specified for use in deciding image processing details related to some of said plurality of images.

4. An image processing method for collectively performing image processes on at least one image with respect to a plurality of processing items, said method comprising the steps of:
a) specifying several pieces of setting data for use in deciding image processing details related to at least one image, said several pieces of setting data each defining processing details with respect to at least one of said plurality of processing items; and
b) deciding said image processing details with respect to each one of said plurality of processing items based on said several pieces of setting data and order of priority between said several pieces of setting data.

5. The method according to claim 4,
wherein, of contents of some of said several pieces of setting data, said contents each defining processing details with respect to an item of said plurality of items, content of setting data assigned the highest priority of some of several pieces of setting data is applied as said image processing details in said step b).

6. The method according to claim 4,
wherein said several pieces of setting data include first setting data and second setting data,
wherein said first setting data is specified for use in deciding image processing details to be shared among all of a plurality of images, and
wherein said second setting data is specified for use in deciding image processing details related to some of said plurality of images.

7. A program product causing a computer to execute the following steps of:
a) specifying several pieces of setting data for use in deciding image processing details related to at least one image, said several pieces of setting data each defining processing details with respect to at least one of a plurality of processing items in image processing; and
b) deciding said image processing details with respect to each one of said plurality of processing items based on said several pieces of setting data and order of priority between said several pieces of setting data.

8. The program product according to claim 7,
wherein, of contents of some of said several pieces of setting data, said contents each defining processing details with respect to an item of said plurality of items, content of setting data assigned the highest priority of some of several pieces of setting data is applied as said image processing details in said step b).

9. The program product according to claim 8,
wherein said several pieces of setting data include first setting data and second setting data,
wherein said first setting data is specified for use in deciding image processing details to be shared among all of a plurality of images, and
wherein said second setting data is specified for use in deciding image processing details related to some of said plurality of images.
